(19) United States
(12) Patent Application Publication
(10) Pub. No.: US 2012/0134830 A1
(43) Pub. Date: May 31, 2012

(54) Safety System for Wind Turbines and Related Wind Turbine

(75) Inventors: Franco Tozzi, Ravenna (IT); Ueli Spalinger, Aesch (CH)

(73) Assignee: TOZZI NORD S.R.I., TRENTO (IT)

(21) Appl. No.: 13/322,318

(22) PCT Filed: May 25, 2010
(86) PCT No.: PCT/IT10/00229

§ 371 Date: Feb. 13, 2012

(30) Foreign Application Priority Data
May 26, 2009 (IT) BO2009A000337

(51) Int. Cl. F03D 11/00; F03D 1/00

(52) U.S. Cl. 416/169 R

(57) ABSTRACT

A safety system for wind turbines and a wind turbine fitted with this safety system. The safety system comprises a propeller shaft adapted to be solidly connected to a wind turbine rotor, an adjustment shaft movable with respect to this propeller shaft for adjusting the pitch angle of at least a rotor blade, actuating means connected to the adjustment shaft for moving it and triggering means of said actuating means being normally disconnected to said actuating means until to overcoming a certain speed of the propeller shaft. The peculiarity of the wind turbine safety system is that triggering means comprise mechanical means connected to the actuating means through direct drive transmission as to overcoming said certain speed for moving said actuating means until rotor blades being safety set. This solution ensures the safety system maximum effectiveness and certainty of operation.

The present invention concerns a safety system for wind turbines and a wind turbine fitted with this safety system. The safety system is of a type such as to prevent the rotation speed of a wind turbine rotor, on which the system is installed, from exceeding a certain threshold considered dangerous for the turbine operation.

Another aspect of this invention concerns a nacelle angular adjusting system regarding a wind turbine tower and a wind turbine fitted with this orientation system.

The application field of this invention is that of wind turbines in general, with particular reference to small and medium sized, horizontal axis wind turbines fitted with mechanisms for controlling the wind rotor blades pitch angle.

More specifically, this invention applies especially but not exclusively to horizontal axis wind turbines where the blades pitch angle adjustment is implemented through the axial displacement of an adjustment shaft, typically coaxial to the power transmission shaft connected to the wind rotor, by the means of levers capable of converting the adjustment shaft displacement into a given rotation of the blades pitch angle. Examples of such control systems are described in documents JP7004344 and CA1188622, where the adjustment shaft displacement is controlled by means of hydraulically or electrically operated actuating means and with continuous linear movement, driven by electrically driven adjusting means, typically electronic devices. These electronic devices process preset parameter information about the turbine and the physical conditions at the site and then control the actuating means providing the pitch adjustment of the blades, so that the wind rotor operates at optimal rpm for an electric generator to convert the power collected from the transmission shaft into electricity to be transmitted to the electric network.

For safety purposes, wind turbines are typically fitted with at least one electro-actuated safety system, which is electrically and/or electronically controlled and electro-mechanical and/or electro-hydraulic operated and which, when dedicated sensors record dangerous conditions for the turbine operation such as the rotor from exceeding a preset angular velocity threshold, ensures that adjusting means (typically electrically operated) reduce the blades pitch angle to the so called blades “feathering”, so as to avoid damaging stresses to the turbine. An important limitation of such safety systems is that, if for any reason no electricity reached the safety system to activate it, the adjusting means would unable to implement the turbine blades safety setting, with the possible and predictable consequences.

Other well known safety systems at the state of the art, such as the system described in document JP 59134385, are triggered and implemented purely by mechanical means. This consists of a double plate frame connecting a blades pitch controlling shaft, on a wind turbine of the type described above, i.e. which is coaxial to the turbine rotation shaft and controlling the rotation of the blades through its longitudinal displacement, to components controlling the rotation of the same blades. This double plate frame, assembled to be longitudinally moved and operated by the pitch controlling shaft, provides resilient elements, placed between the plates, acting in traction when turbine operates in normal conditions. One of the plates is connected to the controlling shaft by means of movable weights, radially and normally secured in a groove of the shaft. When the rotation speed exceeds a set value, the weights are radially moved by centrifugal force, so releasing the concerned plate of the double plate frame such in a way that the resilient elements are free to pull back the moving plate, with the result that the control elements move forward longitudinally so as to decrease the blades pitch angle until the wind turbine blades are safety set.

The arrangement described above is complex and cumbersome due to its double-plate configuration, as well as being sensitive both in activation and the safety system operation and requires regular maintenance because:
with time and stress, the resilient elements of the double plate configuration tend to lose, at least in part, their elastic pull-back capability, so potentially enabling to jeopardize the smooth operation of the safety system;
to implement the system, the weights must slide up against a plate and are usually pulled back by other resilient elements that are normally set to prevent release at rotational speeds less than the one required to trigger the system, such an implementation necessitating timely lubrication of the friction surfaces and continuous monitoring of the quoted actuating device.
   In summary, the double-plate frame as employed is a pre-loaded one which uses the elastic energy of resilient devices both to trigger and to implement turbine blades safety setting and therefore provides all the efficiency and reliability limits concerning the configurations of this type.

In relation to the further aspect of the invention, nacelle angular adjusting system regarding a wind turbine tower currently consists typically of an electric motor, which is fixed to the nacelle to move a pinion which engages a sprocket wheel firmly fixed to the wind turbine tower. Since a wind turbine nacelle is usually aligned in a specific wind direction for long periods of time, this type of adjustment system has the disadvantage that, when it is subjected to winds generating pressures and/or vibrational stresses of aeroelastic nature acting on the yaw axis of the nacelle, the stresses directly and significantly act straight on the teeth respectively engaged by the pinion-sprocket wheel coupling. The engaged teeth, which are limited in number and subjected to major stress cycles over time, may therefore be subject to failure and/or fatigue cracking.

The present invention aims to solve the problems of the known art as above described and to suggest a safety system for wind turbines and a wind turbine fitted with this system, which achieve the highest operational reliability in any operative conditions, even after years of use; as well as to suggest a nacelle angular adjusting system regarding a wind turbine tower and a wind turbine fitted with such a system, which minimizes the risk of fatigue failure in system components, also resulting in simple, versatile and economical manufacture.

One objective of the present invention is to provide automatic, safe and reliable safety setting i.e. feathering of the wind turbine blades when the rotor angular velocity exceeds a given preset value.

One objective of the invention is that the safety system is triggered and actuated only by the rotor speed exceeding a given angular velocity, independently of the proper operation of the mechanisms and equipment of the wind turbine on which it is installed, as well as of the ambient physical conditions.

Another objective is that, to be properly operated, the safety system would not have to require any regular or special monitoring or maintenance thereof.

To achieve these objectives, the subject of this invention is a wind turbine safety system, a nacelle angular adjusting system regarding a wind turbine tower and a wind turbine fitted with such a system in accordance with the features of the attached claims, which form an integral part of the present description.

The wind turbine safety system according to the invention comprises a propeller shaft adapted to be solidly connected to a wind turbine rotor, an adjustment shaft movable with respect to this propeller shaft for adjusting the pitch angle of at least a rotor blade, actuating means connected to the adjustment shaft for the movement thereof and triggering means of said actuating means for blade safety setting as to coming through a certain speed of the propeller shaft.

A main peculiarity of the wind turbine safety system according to the invention is that the triggering means comprise mechanical means connected to the actuating means through direct drive transmission, for moving the actuating means until rotor blades being safety set. This arrangement ensures the safety system maximum effectiveness in operation because the direct rive transmission allows the triggering means, continuously and without any possibility of disengagement, to drive the actuating means and hence the adjustment shaft to its maximum extension or elongation in a safety position for the turbine blades, thus providing a safety system trigger that is secure, reliable and stable regardless of the wind turbine operating conditions.

Another peculiarity is that the actuating means comprise direct drive transmission mechanical means for their complete actuation until rotor blades are safety set. Advantageously, such feature enables the safety system to be safely, efficiently, reliably and completely actuated.

The actuating means and the triggering means are also of a purely mechanically operated type, so ensuring a reliable and safe actuation, which is proof against any failure or malfunction of an electrical and/or hydraulic and/or electro-hydraulic type.

The invention in subject allows a automatic, stable and permanent safety setting to be achieved, with no possibility of the system failing to operate or partially operate. Once the safety system is triggered, it may actually be returned to the normal operation or output only with the external involvement of an operator, who restores the normal operation by returning the actuating and triggering means to the operating or generating settings, where the triggering means direct drive transmission is inactive, as will become clear later on in the description.

Other objectives, characteristics and advantages of this invention will become apparent from the following detailed description of a preferred implementation example of the invention, which is provided as a purely explanatory and non-restrictive example, with the contribute of the attached figures, in which:

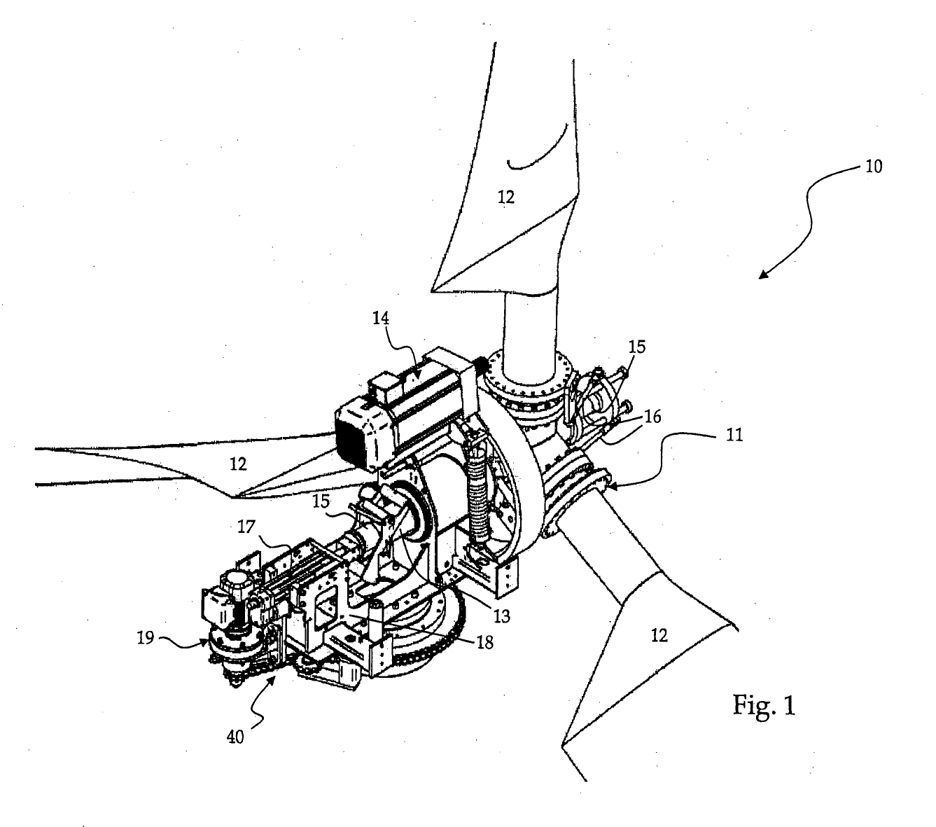

FIG. 1 represents a perspective view of the nacelle, without its cover, of a wind turbine according to the invention, specifically of the horizontal axis type with axial pitch adjustment;

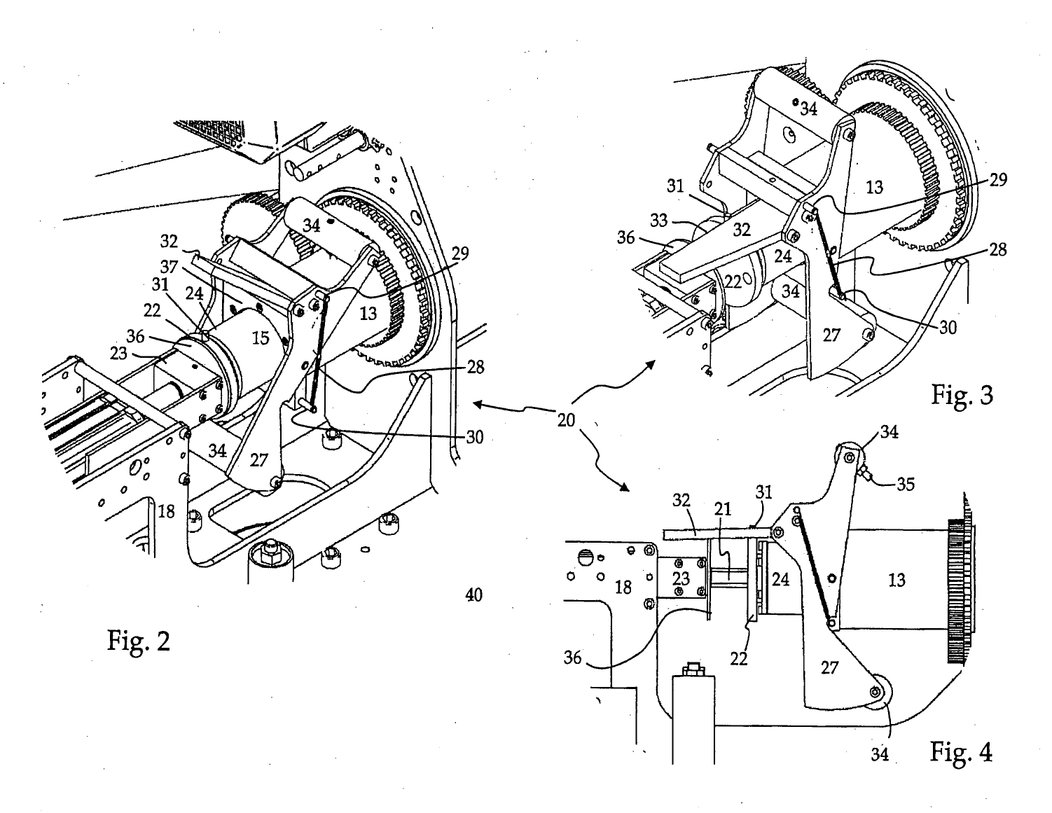

FIG. 2 represents a perspective view of a safety system on the wind turbine of FIG. 1 according to the invention, with the turbine in operating or generating condition, i.e. where the system has not been triggered.

FIGS. 3 and 4 represent respectively a perspective and a side view of the safety system of FIG. 2, after the safety system has been triggered;

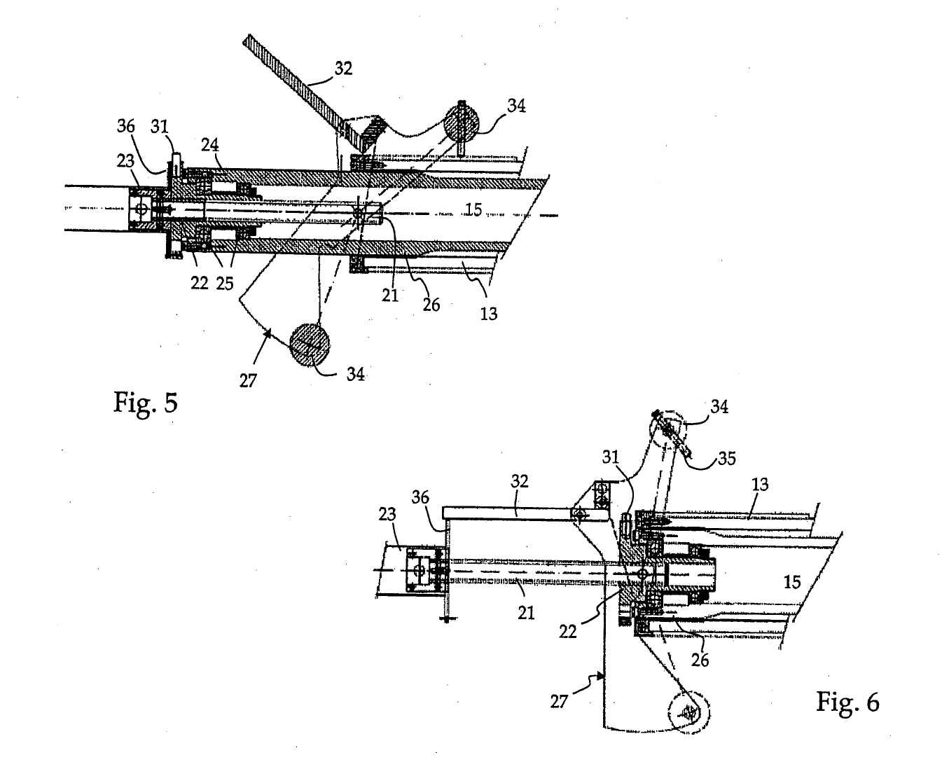

FIG. 5 shows a sectional view along a central longitudinal plane of the safety system according to the invention as shown in FIG. 2, i.e. where the safety system has not been triggered;

FIG. 6 shows a sectional view along a central longitudinal plane of the safety system, where the wind turbine blades have reached a safe position;

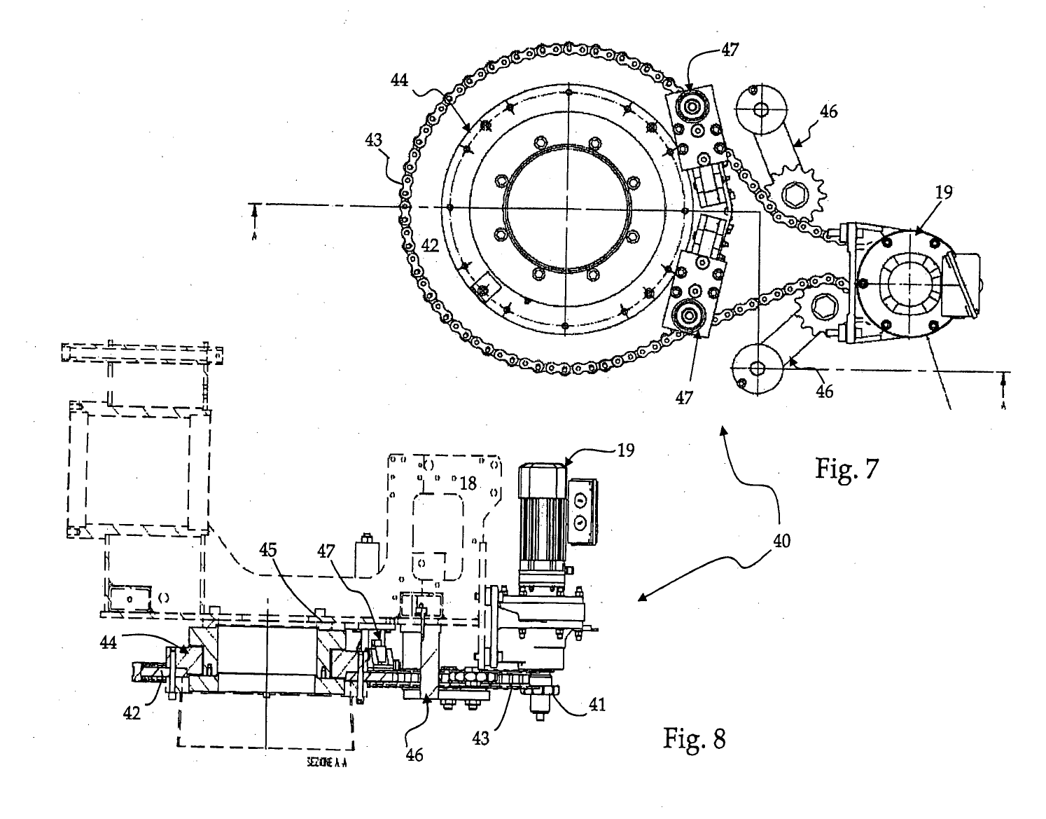

FIGS. 7 and 8 respectively illustrate a top view and a sectional elevation, specifically along the line AA of FIG. 7, of a nacelle angular adjusting system regarding a wind turbine tower according to the invention.

With reference to FIG. 1, with 10 a wind turbine as a whole is referred to, which shows the sole nacelle without its cover for simplicity reasons. It comprises a wind turbine rotor 11 provided of blades 12 being attached to rotate around its longitudinal axis for adjusting the relevant pitch angle with respect to the wind running over the turbine 10. The rotor 11 is rigidly connected to a power transmission or propeller shaft 13, which is capable of transmitting the movement of the rotor 11 to an electric generator 14, which is specifically of the permanent magnet type.

The wind turbine 10 is of a horizontal axis type with adjustment of the pitch angle of the blades 12, where the above said adjustment is worked out by axial displacement of an adjustment shaft 15, which is coaxial to the propeller shaft 13, by the means of interposed levers 16 capable of converting the displacement of the adjustment shaft 15 into a given fixed rotation of the blades 12 pitch angle. An actuator 17, specifically of an electrically operated step by step type, is connected to the adjustment shaft 15 for moving it in an axial direction on the turbine normal operating or generating conditions, the actuator 17 being controlled in a known way by a turbine 10 operational system providing to control the displacement of the shaft 15 according to the physical and structural conditions of the wind turbine and the ambient environment, such in a way to accordingly adjusting the pitch angle of the blades 12 and hence the rotational speed of the wind turbine rotor 11.

The turbine 10 is fitted with a nacelle angular adjusting system regarding a wind tower on which the nacelle is located, denoted with 40. The adjustment system 40, which represents one aspect of this invention, provides angular adjustment of the nacelle frame 18 by means of an electric motor 19, which is fixed to the frame 18 as specified below.

The wind turbine 10 is also fitted with a safety system according to the present invention, denoted in its entirety with 20, connected to the actuator 17 and to the propeller shaft 13 and the adjustment shaft 15, which is able to prevent the rotational speed of the wind turbine rotor 11 from exceeding a certain threshold considered as dangerous for the turbine 10 operation, as will be apparent later on in the description. With reference to FIGS. 2 to 6, the safety system 20 comprises the propeller shaft 13 which, as seen, is solidly connected to the wind turbine rotor 11, the adjustment shaft 15 axially and longitudinally movable with respect to the propeller shaft 13 for adjusting the pitch angle of the rotor 11 blades 12, and actuating means connected to the adjustment shaft 15 for moving it, specifically direct drive transmission mechanical means being constituted, for example, of a threaded mating between a worm screw 21 and a lead nut 22, being movable in normal operating conditions only following axial displacement and solidly with the adjustment shaft 15, as shown in FIG. 5. More specifically, the screw 21 is connected to an extremal part 23 of a actuator 17 pusher ending with a disc washer 36, while the lead nut 22 is mounted so that it can rotate by the means of first bearings means 25 herein interposed, fully seated inside on and against an end hollow section 24 of the adjustment shaft 15, as clearly apparent in the sections of FIGS. 5 and 6. The adjustment shaft 15, coaxial and internal to the propeller shaft 13, is able to slide longitudinally due to the interposition of second bearings means 26, in particular plain bearings.

The safety system 20 further comprises triggering means of the actuating means, in the example a centrifugal mass 34 rocker arm 27, centrally hinged to a plate 37 firmly fixed to the propeller shaft 13, where the relative rotation is resisted by resilient means 28 provided between a first stop 29 firmly fixed to the rocker 27, and a second stop 30 firmly fixed to the propeller shaft 13 for implementing the blades safety setting once the propeller shaft 13 has exceeded a certain rotational speed. The triggering means in turn comprise mechanical means associated to the actuating means 21, 22 by direct drive transmission, for moving the actuating means until rotor 11 blades 12 are safety set. In the example, the direct drive transmission mechanical means consist of a pin component 31 being solid with the lead nut 22, from which it radially protrudes, and of a shaped lever 32 of the rocker arm 27 which is able, when the propeller shaft 13 and consequently the rocker arm 27 reach a certain rotation speed, to interfere with the pin component 31 through a shaped side surface 33 thereof, so as to create the direct drive transmission between the shaped lever 32 and the pin component 31. The actuation of the direct drive transmission will be more apparent through the subsequent description of the safety system 20 operation according to the invention.

When the wind turbine 10 is in operating or generating conditions, i.e. at rotation speeds far away from the critical speed at which the safety system 20 needs to be involved, as specifically illustrated in FIGS. 2 and 5, the rocker arm 27 rotates together with the propeller shaft 13 because it is hinged to the plate 37, which is securely fixed to the shaft 13 in a substantially inclined position with respect to a horizontal plane, i.e. so as the lever 32 provides a gap between itself and the pin component 31 and therefore does not interfere with it while rotating. The pin component 31 results in being substantially standstill fixed to the worm screw 21 and lead nut 22 mating.

With particular reference to FIGS. 3, 4 and 6, when the wind turbine 10 propeller shaft 13 reaches the specific rotation speed as considered critical for the turbine, and when the action of an electronic pitch control system, which normally provides the safety setting for the blades by means of the actuator 17 until they reach the above critical speed, is inhibited, the rocker arm 27 centrifugal masses 34 constantly resisted by the resilient means 28, rotate the same rocker arm 27 into a substantially vertical position, by bringing the lever 32 to a substantially horizontal position with the lateral surface 33 interfering with the pin component 31, which is driven in rotation at the same speed as the propeller shaft 13. This causes the lead nut 22 to rotate on the worm screw 21 which, as it abuts the end section 24 of the adjustment shaft 15, drives it in longitudinal displacement to generate a lower angle of incidence of the blades 12 until to the point of feathering the blades 12, thereby slowing the rotation of the wind rotor 11 and working out the wind turbine safety settings. When at the end of stroke, the lead nut 22 no longer engages with this pin 31 against the lever 32 lateral surface 33 since, in its longitudinal displacement, it overruns all the interference positions (FIG. 6) and is therefore free to rotate with the wind rotor 11, which is now in safety mode.

From the above description of the operation, it is clear that the triggering and actuating means according to the present invention are of a type such as to achieve automatic triggering of the safety system, which occurs due to the action of the triggering means, which comprise mechanical means associated to the actuating means by direct drive transmission, as well as an automatic release of the triggering means once the turbine safety setting configuration is fully worked out; specifically this is achieved in the above example when the lead nut has been longitudinally displaced in a sufficient manner as to work out the turbine safety setting, an action which results to be irreversible unless it is intended to stop the turbine and proceed as described below.

The direct drive transmission implementation, which is particularly in the above example obtained between the shaped lever 32 and the pin component 31, advantageously leads to the most effective operation of the safety system because there is no possibility of failing to be triggered and therefore of not bringing the adjustment shaft 15 to a safe position, except in the event of major and improbable mechanical failures. Therefore, whatever the physical conditions around the turbine 10, the safety system 20 according to the invention operates without any possibility of error and of not implementing the safety setting for the wind turbine rotor 11 blades 12. In addition, once triggered, the safety system cannot unlock itself without outside intervention by an operator until the propeller shaft 13 rotating has finished. In the example illustrated, in order to restore the wind turbine 10 to a normal operation, an operator has to manually tilt the rocker arm 27 until to re-establish a gap between the lever element 32 and the pin component 31, bring the adjustment shaft 15 back into the generating position by rotating the lead nut 22 until it comes into contact with the disc 36, on which the lever 32 rests under operating conditions when safety setting is active (FIG. 6), so restoring the safety system 20 to the turbine normal operating or generating position (FIGS. 2 and 5).

In conclusion, the triggering means direct drive transmission produces a continuous and constant driving force until the operation of the actuating means is definitive and cannot be accidentally reversed, causing the turbine safety setting which is implemented by longitudinal displacement of the adjustment shaft 15, so ensuring the maximum operational efficiency and reliability of the safety system according to the invention.

In greater constructive details of the safety system 20, the rocker arm 27 is preferably of a type with centrifugal masses 34 being easily detachable and replaceable with ones with different mass values, by using attachment and release devices of a known type. The rocker arm 27 may advantageously be fitted with devices for fine adjustment of the distance between the centrifugal masses 34 and the rotation axis, for example a screw adjuster device 35. Moreover, the shaped lever 32 should preferably be rigidly fastened to the rocker arm 27 by the means of an angularly adjustable hinge device of a type known in the industry, which allows the inclination to be adjusted in relation to the rocker arm 27. The resilient means may advantageously be elastic springs 27 and ones that can simply be replaced with springs of a different elastic constant. These arrangements advantageously allow the safety system 20 to make fine adjustments to its operational speed in order to activate the safety setting, i.e. to feather the wind turbine rotor 11 blades 12. Advantageously, It can also varied the system capability to intervene within a broad range of propeller shaft 13 rotation speeds, which results in great flexibility and is applicable to any type of wind turbine, small, medium or large sized.

In FIGS. 7 and 8 details of the angular adjustment system 40 of the nacelle regarding a wind turbine 10 tower according to another aspect of the present invention are shown, wherein for clarity reasons some important but not relevant details, including the turbine tower, have been omitted. The electric motor 19 can be seen in the above figures, which is securely fixed to the frame 18 of the nacelle (shown with broken lines in FIG. 8) and adapted to rotate a drive element of a mechanical transmission, in particular a driving gear, a pinion 41 in the example. The mechanical transmission responsible for handling the adjustment system 40 also consists of a driven element, in particular a driven gear such as a sprocket wheel 42 and means for the elastic-damped transmission of the movement between the drive 41 and driven 42 elements including, in the above example, a drive chain 43 specifically of metal mesh, as well as flexible coupling tensioning means for the elastic-damped transmission 43 with the function of cushioning and damping the stresses acting on the mechanical transmission, in the example a pair of chain tightening pulley 46.

The expression “devices for elastic-damped transmission” should be understood in this document to mean all the means capable of transmitting motion between driven and drive elements by providing a certain elastic and damping function during their respective operation: for example chain drive means such as metal mesh chain drives, belt drive means such as rubber and/or metal belts of any type suitable for motion transmission, especially but not limited to when they are coupled with flexible coupling tensioning devices such as chain and/or belt tensioning tightening pulleys.

It can therefore also be beneficial for the mechanical transmission which is the basis of the adjustment system in this invention to be of a type that is elastic-damped, so that the stresses are partially cushioned at peak intensity by the relevant devices, such as when adjusting the nacelle and/or when there are strong and sudden gusts of wind. Additionally, fatigue stresses on the driven and drive elements are distributed over a substantial area, in the above example over a good proportion of the respective pinion 41 and sprocket wheel 42 teeth. This leads to the components of the adjustment system having greater durability and resistance to fatigue and consequently to the system and wind turbine it is fitted to having greater reliability.

The flexible coupling tensioning mechanisms effectively achieve the correct working tension for the mechanical transmission 41-43 for proper operation and precise rotation of the nacelle in relation to the tower, the chain tensioners with pinion 46 being fixed in pairs to the load-bearing frame 18 on opposite sides of the drive chain 43 and operating on it with a force acting from the outside in to achieve the tensile stress required. The tensioning devices then help to make the operation of the adjustment system according to the invention efficient and substantially free of routine maintenance because, once regulated and adjusted, they require no routine maintenance and allow the mechanical transmission to maintain the correct tension.

In greater detail, the driven element, namely the sprocket wheel 42, is firmly fixed to the turbine tower with a flange connection to a support 44 for the nacelle, where a third set of bearings, specifically plain bearings 45, are fitted between this support 44 and the load-bearing frame 18 of the nacelle, facilitating its angular movement in relation to the tower.

The rotation of the nacelle regarding the tower occurs through actuation of the electric motor 19, which moves the drive element, i.e. the pinion 41, which acts on the drive chain 43 and therefore on the driven element, i.e. the sprocket wheel 42. As the driven element, namely the sprocket wheel 42 is firmly fixed to the tower and therefore stationary in relation to the ground on which the turbine 10 is installed, when the electric motor 19 turns the pinion 41, the chain 43 turns around the crown wheel 42 and it is the motor 19 that moves, mounted on the load-bearing frame 18 of the nacelle, which is correspondingly angled according to the command.

The adjustment system 40 also comprises brake devices 47, anchored to the load-bearing frame 18, for holding the nacelle in a given operating position. When applied, the brake devices can effectively maintain the nacelle in an operational position and transfer the aeroelastic stresses acting on the nacelle onto these devices, thereby relieving the stresses acting on the mechanical transmission components.

It is apparent that, for those in the field, there are numerous possible variations to the wind turbine safety system, the nacelle angular adjustment system regarding a wind turbine tower and a wind turbine fitted with such systems according to the invention, as well as it is apparent that, in their practical implementation, the forms of the details as described may be different and replaced by the means of technically equivalent components.

For example, the triggering means may consist of a friction device annularly fitted around the adjustment shaft, which can be actuated, for example, by an eccentric mass rotor being able to longitudinally shift on reaching a certain preset critical speed, so triggering the friction device and driving the actuating means in rotation to implement the turbine blades safety setting.

The actuating means may consist of any mechanism for motion transmission, in particular one capable of providing a direct drive transmission, which works out a relative displacement between two elements of the same mechanism.

The mechanical transmission, on which the system of adjusting a nacelle in relation to a wind turbine tower is based, may consist, for example, of a trapezoidal belt linking the movements of one driving and one driven pulley or else a toothed belt connecting a pair of gear wheels and fitted with dedicated belt tensioning devices.

1. A wind turbine safety system, comprising:
a propeller shaft adapted to be solidly connected to a wind turbine rotor,
an adjustment shaft movable with respect to said propeller shaft for adjusting the pitch angle of at least a rotor blade,
actuating means connected to the adjustment shaft for the movement thereof, and
triggering means of said actuating means being normally disconnected to said actuating means until to overcoming a certain speed of the propeller shaft,
wherein the triggering means comprise mechanical means connected to said actuating means through direct drive transmission upon overcoming said certain speed for moving said actuating means until rotor blades being safety set.

2. The system according to claim 1, wherein, when the wind turbine is in configuration of rotor blades safety setting, the triggering means are disconnected to the actuating means.

3. The system according to claim 1, wherein said direct drive transmission comprises a interfering coupling of said triggering means for the actuating means movement until to rotor blades safety setting.

4. The system according to claim 3, wherein the interfering coupling comprises a pin element fixed to the actuating means being in contact with a shaped lever of the triggering means.

5. The system according to claim 1, wherein the actuating means comprise direct drive transmission mechanical means for the complete actuation thereof until the rotor blade being safety set.

6. The system according to claim 1, wherein said actuating means and triggering means are of a mechanical operated type, in particular of an exclusively mechanical operated type.

7. The system according to claim 1, wherein said adjustment shaft is connected to an actuator adapted to adjust the adjustment shaft displacement for adjusting the blades pitch angle.

8. The system according to claim 1, wherein the actuating means comprise a threaded mating between a worm screw and a lead nut for the adjustment shaft displacement.

9. The system according to claim 8, wherein the worm screw is connected to an extremal part of a pusher of an actuator adapted to adjust the adjustment shaft displacement for adjusting the blade pitch.

10. The system according to claim 8, wherein the lead nut is rotably mounted inside and laying on an extremal hollow section of the adjustment shaft.

11. The system according to claim 1, wherein said triggering means comprise a centrifugal masses outrigger centrally hinged to a propeller shaft portion for direct drive transmission implementation.

12. The system according to claim 11, wherein the triggering means comprise a pin element solidly and overhanging mounted on a lead nut support, and a shaped lever of the outrigger which is adapted, as the propeller shaft raises a certain rotation speed, to interfere with the pin element by the means of a lateral shaped surface thereof to implement a direct drive transmission between the shaped lever and the pin element.

13. The system according to claim 12, wherein, when the wind turbine is in configuration of definitive rotor blades safety setting, the shaped lever is not any more in contact with the pin element because the lead nut is displaced of such a distance to not interfere with the pin element.

14. The system according to claim 11, wherein the outrigger is of a type comprising centrifugal masses being easily unfastenable and replaceable with masses of different value.

15. A wind turbine, comprising:
a rotor provided of blades rotably connected around the own longitudinal axe, the rotor being rigidly connected to a propeller shaft adapted to transmit the rotor movement to an electric generator,
an adjusting shaft, and
levers adapted to transform the adjusting shaft movement in a blade pitch angle rotation, and
a safety system according to claim 1.
